(19) United States
(12) Patent Application Publication
(10) Pub. No.: US 2026/0305650 A1
(43) Pub. Date: Oct. 8, 2026

(54) A DOUBLE-LAYERED GEL-BALL AND PROCESS OF MANUFACTURING THE SAME AND USE THEREOF

(71) Applicant: Cargill, incorporated, Wayzata, MN (US)

(72) Inventors: Zhaolin HAO, Beijing (CN); Ruijie LI, Shanghai (CN); Ying ZHAO, Beijing (CN); Jinjin ZHOU, Shanghai (CN); Xiaoyan ZONG, Beijing (CN)

(73) Assignee: Cargill, incorporated, Wayzata, MN (US)

(21) Appl. No.: 19/485,050

(22) PCT Filed: May 23, 2024
(86) PCT No.: PCT/CN2024/094839

§ 371 Date: Nov. 17, 2025

(30) Foreign Application Priority Data
May 23, 2023 (CN) 202310588049.2
Jan. 18, 2024 (CN) 202410076718.2

(51) Int. Cl. A23G 9/48; A23L 29/256; A23P 20/20

(52) U.S. Cl. CPC A23G 9/48; A23L 29/256; A23P 20/20

(57) ABSTRACT

A rounded object, preferably a gel-ball. The gel-balls are suitable to be added to food, feed, beverage, cosmetic or pharmaceutical products. The gel balls have a core and an outer skin that at least partially encloses the core, and the core and the outer skin lie in two different layers that are separable from each other. Also includes a frozen gel-ball that is cold-resistant. Also includes to a process of manufacturing the gel-balls.

### CROSS-REFERENCE TO RELATED APPLICATIONS

This application claims the benefit of Chinese Patent Application No. 202310588049.2, filed May 23, 2023, Chinese Patent Application No. 202410076718.2, filed Jan. 18, 2024, each which are incorporated by reference herein in its entirety.

### FIELD OF THE INVENTION

The present invention relates to the technical field of food processing, particularly relates to a gel-ball and a preparation method thereof.

### BACKGROUND

There are many different kinds of gel-ball products on the market for being added to food, feed, beverage, cosmetic or medicine to enhance their layering texture or taste. There are some crystal ball products with blasting mouthfeel on the market. For example, Chinese patent CN108208765A discloses an alginate crystal ball and a preparation method thereof, wherein the alginate crystal ball consists of a crystal ball shell and a crystal ball core wrapped in the crystal ball shell. However, the inner core of this alginate crystal ball products with blasting mouthfeel is not a solid but a liquid or liquid with a high consistency, which cannot provide the texture and mouthfeel of a gel-ball of which both the inner and outer layers are solid.

Chinese patent CN112841612A discloses a kanten crystal ball and a preparation method thereof. The kanten crystal ball is in a single-layer agar structure, which does not have the structure and texture of more than two layers, not being able to provide rich layerings and mouthfeel.

### SUMMARY

The present invention relates to a rounded object preferably a gel-ball suitable to be added to food, feed, beverage, cosmetic or pharmaceutical products, comprising: a core comprising a core gel network comprising a humectant and a gelling agent; and an outer skin at least partially enclosing said core, said skin comprising a skin gel network comprising calcium alginate, wherein the core and the outer skin lie in two different layers that are separable from each other. The present invention further relates to a process of manufacturing a rounded object preferably a gel-ball suitable to be added to food, feed, beverage, cosmetic or pharmaceutical products. The present invention further relates to a rounded object preferably a gel-ball obtained by the process described herein.

In one aspect, the rounded object according to the present invention can be a gel-ball. In one aspect, the rounded object preferably a gel-ball according to the present invention has a grape-like two-layer structure. In one aspect, in the two-layer structure of the rounded object preferably a gel-ball according to the present invention, the outer skin and the core are both solid (e.g. not flowable under room temperature). In one aspect, the outer skin and the core are both elastic. In one aspect, the rounded object preferably a gel-ball according to the present invention is a heat-resistant gel-ball, e.g. it can tolerate a temperature of up to 95-121° C.

The present invention provides a frozen rounded object preferably a frozen gel-ball suitable to be added to food, feed, beverage, cosmetic or pharmaceutical products, comprising a gelling agent, an alginate salt, a humectant, and a first sugar, wherein the frozen gel-ball includes a core and an outer skin that at least partially encloses the core, and the core and the outer skin lie in two different layers that are separable from each other before frozen. Preferably, the frozen rounded object is cold-resistant. Preferably, the frozen rounded object is chewy and/or elastic at temperatures below 0° C.

The present invention provides a frozen rounded object preferably a frozen gel-ball suitable to be added to food, feed, beverage, cosmetic or pharmaceutical products. The present invention provides a process of manufacturing a frozen rounded object preferably a frozen gel-ball suitable to be added to food, feed, beverage, cosmetic or pharmaceutical products. The present invention further provides a frozen rounded object, preferably a frozen gel-ball obtained by the process described herein.

The present invention provides use of the rounded object preferably the gel-ball discussed in frozen application. The present invention also provides use of the frozen rounded object (preferably the frozen gel-ball) discussed in food, feed, beverage, cosmetic or pharmaceutical products, preferably in cold food or cold beverage. Preferably, the frozen rounded object is cold-resistant. Preferably, the frozen rounded object is chewy and elastic when used in the frozen applications.

In one aspect, the frozen rounded object according to the present invention can be a frozen gel-ball. In one aspect, the rounded object preferably a gel-ball according to the present invention has a grape-like two-layer structure. In one aspect, in the two-layer structure of the rounded object preferably a gel-ball according to the present invention, the outer skin and the core are both solid (e.g. not flowable under room temperature) before frozen. In one aspect, the outer skin and the core are both elastic. In one aspect, the rounded object preferably a gel-ball according to the present invention is a heat-resistant gel-ball, e.g., it can tolerate a temperature of up to 95-121° C. In one aspect, the rounded object preferably the gel-ball is also cold-resistant and can tolerate a temperature of 0° C. to −50° C., or from −10° C. to −20° C., or from 0° C. to −10° C., or from −12° C. to −18° C.

### BRIEF DESCRIPTION OF THE DRAWINGS

FIG. 1 is a schematic drawing of the cross section of the gel-ball of the present invention, illustrating that the gel-ball 100 has an outer skin 102 and a core 104.

FIG. 2 is a photograph showing the overall appearance and the two-layer structure of the gel-ball of Example 1, illustrating that the gel-ball 200 has an outer skin 202 and a core 204, wherein the skin 202 and core 204 are separable.

FIG. 3 is a photograph showing the two-layer structure of the gel-ball of Example 2, illustrating that the gel-ball 300 has an outer skin 302 and a core 304.

FIG. 4 is a photograph showing the overall appearance and the two-layer structure of the gel-ball of Example 3, illustrating that the gel-ball 400 has an outer skin 402 and a core 404, wherein the skin 402 and core 404 are separable.

FIG. 5 is a photograph showing the overall appearance of the gel-ball 500 of Comparative Example 2.

FIG. 6 is a photograph showing the overall appearance of the gel-ball 600 of Comparative Example 3.

FIG. 7 is a photograph showing the appearance of the gel-ball of Example 1 after sterilization, illustrating that the gel-ball 210 has an outer skin 212 and a core 214 after sterilization.

FIG. 8A is a photograph showing the appearance of the gel-ball 306 of Example 2 before sterilization.

FIG. 8B is a photograph showing the appearance of the gel-ball of Example 2 after sterilization, illustrating that the gel-ball 310 has an outer skin 312 and a core 314 after sterilization.

FIG. 9 is a photograph showing the appearance of the gel-ball of Example 3 after sterilization, illustrating that the gel-ball 410 has an outer skin 412 and a core 414 after sterilization.

FIG. 10 is a photograph showing that the appearance of the gel-ball 510 of the Comparative Example 2 after sterilization.

FIG. 11A is a photograph showing the appearance of the gel-ball 606 of Comparative Example 3 before sterilization.

FIG. 11B is a photograph showing the appearance of the gel-ball 610 of Comparative Example 3 after sterilization.

FIG. 12A is a photograph of gel-ball 4 before frozen.

FIG. 12B is a photograph of frozen gel-ball 4.

FIG. 12C is a photograph of gel-ball 5 before frozen.

FIG. 12D is a photograph of frozen gel-ball 5.

FIG. 12E is a photograph of gel-ball 6 before frozen.

FIG. 12F is a photograph of frozen gel-ball 6.

FIG. 12G is a photograph of tapioca balls before frozen.

FIG. 12H is a photograph of tapioca balls after frozen.

### DETAILED DESCRIPTION

Unless otherwise noted, all measurements, weights, lengths etc. are in metric units, and all temperatures are in degrees Celsius. It is understood that unless otherwise specifically noted, the materials compounds, chemicals, etc. described herein are typically commodity items and/or industry-standard items available from a variety of suppliers and sources worldwide.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1-5%” should be interpreted to include not just about 0.1 to about 5%, but also the individual values (e.g. 1%, 2%, 3% and 4%) and the sub-ranges (e.g., 0.1%-0.5%, 1.1%-2.2%, 3.3%-4.4%) within the indicated range. And for example, “95-121° C.” not only includes 95-121° C. but also the individual values (e g. 95° C., 96° C., 97° C., etc.) and the sub-ranges (e.g., 95-97° C., 96-100° C., 100-121° C.) within the indicated range. The statement “about X to Y” has the same meaning as “about X to about Y”, unless indicated otherwise. Likewise, the statement “about X, Y or about Z” has the same meaning as “about X, about Y or about Z”, unless indicated otherwise.

As used herein, the singular forms “a,” “an,” and “the” include plural referents unless the context clearly dictates otherwise. For example, reference to “a substituent” encompasses a single substituent as well as two or more substituents, and the like. It is understood that any term in the singular may include its plural counterpart and vice versa.

The term “or” is used to refer to a nonexclusive “or” unless otherwise indicated. The statement “at least one of A and B” has the same meaning as “A, B, or A and B.”

Unless otherwise specified, as used herein, the term “substantially” refers to mostly or predominantly, for example at least 50%, 60%, 70%, 80%, 90%, 95%, 96%, 97%, 98%, 99%, 99.5%, 99.9% or more.

As used herein, the terms “for example, “for instance,” “such as,” “e.g.”, or “including” are meant to introduce examples that further clarify more general subject matter. Unless otherwise specified, these examples are provided only as an aid for understanding the applications illustrated in the present disclosure and are not meant to be limiting in any fashion.

The term “about” as used herein can allow for a degree of variability in a value or range, for example, within 10%, within 9%, within 8%, within 7%, within 6%, within 5%, within 4%, within 3%, within 2%, or within 1% of a stated value or of a stated limit of a range and includes the exact stated value or range.

### Gel-Ball

The term “gel-ball” as used herein relates to a rounded object that is solid and soft. The gel-ball is elastic with a gelatinous or slippery texture. The gel-ball has an elastic structure. The gel-ball disclosed herein is heat-resistant as well as cold-resistant.

The term “elastic” as used herein relates to a property of a gel-ball, outer skin, and/or core to deform or elongate under an applied external force, and to return substantially to its original shape or length when the external force is removed. It will be understood that the applied external force is not sufficient to destroy the gel-ball but is only sufficient to deform or elongate the gel-ball.

The term “chewy” as used herein relates to a property of a gel-ball to be masticable, e.g., deform or elongate under an applied external force in the jaw of a consumer.

The present invention relates to a rounded object preferably a gel-ball suitable to be added to food, feed, beverage, cosmetic or pharmaceutical products. The gel-ball comprises a core and an outer skin at least partially enclosing the core. The core comprises a core gel network, preferably the core gel network comprises a humectant and a gelling agent. The outer skin comprises a skin gel network comprising calcium alginate. The core and the outer skin lie in two different layers that are separable from each other. The outer skin may be peelable from the core of the gel-ball. In one aspect, the core gel network and the skin gel network do not intermingle with each other at the junction between the core and the outer skin.

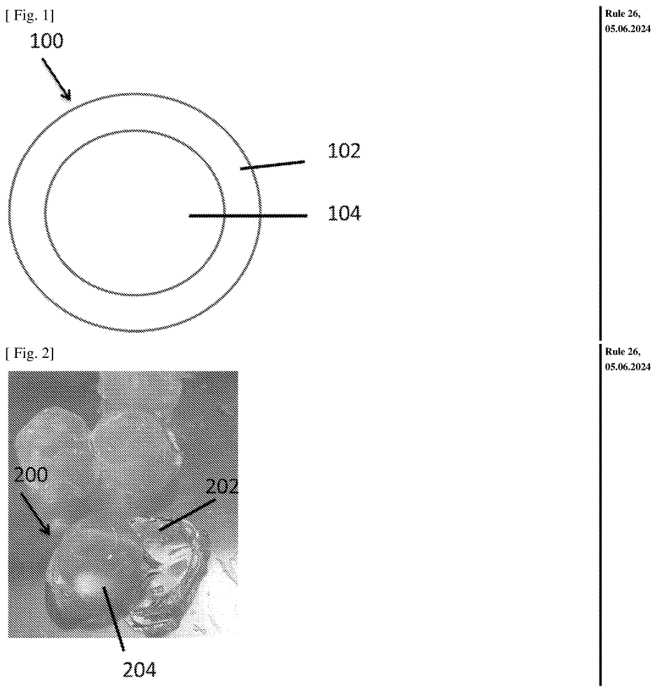

In one aspect, the rounded object according to the present invention is a gel-ball. In one aspect, the gel-ball is in grape-like shape, such as round-shaped, oblate-shaped, oblong-shaped, oval-shaped, heart-shaped, egg-shaped, obovate-shaped, etc. In one aspect, the rounded object preferably a gel-ball has a grape-like two-layer structure, i.e., an outer skin and a core. For example, FIG. 1 shows a gel ball 100 that includes an outer skin 102 and a core 104. In one aspect, both the outer skin and the core are solid (e.g. in a non-flowable state at room temperature). In one aspect, the outer skin and the core have different textures, for example, like the skin and pulp of a grape having different textures. In one aspect, the gel-ball is elastic. In one aspect, both the outer skin and the core are elastic. The elasticity of the outer skin and the core may be different. The elasticity of the outer skin and the core may be the same. In one aspect, elasticity refers to the property of a gel-ball, outer skin, or core to deform or elongate under an applied external force, and to return substantially to its original shape or length when the external force is removed.

In one aspect, the outer skin comprises a skin gel network comprising calcium alginate. In one aspect, the texture of the outer skin comprising the skin gel network comprising calcium alginate is different from the texture of the core comprising a core gel network comprising a humectant and a gelling agent. In one aspect, the core and the outer skin lie in two different or distinct layers that are separable and/or peelable from each other. By distinct, it is meant that the core and the outer skin are not intermingled but layered as separate structural components. “Separable from each other” means that the outer skin and the core can be separated or means that the outer skin can be peeled off from the core, like the skin and pulp of a grape, and the outer skin and the core are not adhered after separation/peeling. Preferably, the core of the gel-ball is not damaged or disintegrated when the outer skin is separated from the core of the gel-ball.

In one aspect, the rounded object, preferably a gel-ball according to the present invention is heat-resistant, for example, the rounded object preferably a gel-ball is resistant to a temperature of about 95-121° C. In one aspect, the gel-ball maintains integrity when exposed to a temperature of 95-121° C. In one aspect, the gel-ball maintains integrity when exposed to a temperature of 95-121° C. for 5 to 15 minutes. In one aspect, heat-resistance refers to the ability to substantially maintain its original properties, including shape, texture, integrity, elasticity, and/or mouthfeel, etc. under heating conditions, e.g. at a temperature of 95-121° C. In one aspect, the rounded object preferably a gel-ball is not heat resistant as it is used in food and/or beverages that do not need to go through heat treatment, such as iced Boba tea. In one aspect, the rounded object preferably a gel-ball is cold resistant and can be used in cold food and/or beverages. In one aspect, the rounded object preferably a gel-ball is both heat resistant and cold resistant.

“Maintaining integrity” described herein means that the overall structure of the rounded object, preferably a gel-ball remains the same or substantially the same before and after it is exposed to external force and/or conditions, e.g., heat or frozen. For example, after being heated, the outer skin of the gel-ball still encloses the core, and the outer skin and the core remain in two different layers. For example, after being frozen, the outer skin of the gel-ball still encloses the core, and the outer skin and the core remain in two different layers.

In one aspect, the rounded object, preferably a gel-ball according to the present invention is cold-resistant. The term “cold resistant” means that the gel-balls exhibit chewy and/or elastic properties at cold temperatures, e.g. below 0° C., or from 0° C. to −50° C., or from −10° C. to −20° C., or from 0° C. to −10° C., or from −12° C. to −18° C.

In one aspect, the frozen gel balls do not have to be thawed prior to use in frozen application. The gel balls are consumed in the frozen food without thawing and are still substantially elastic and chewy at cold temperatures.

The cold-resistant, double-layered gel-balls of the present invention can be used in frozen applications. The inventors also discovered that all alginate gel-balls are cold resistant and thus can be used in frozen applications.

In one aspect, the rounded object preferably a gel-ball according to the present invention is substantially spherical such as round-shaped, oblate-shaped, oblong-shaped, oval-shaped, heart-shaped, egg-shaped, obovate-shaped, etc.

In one aspect, the outer skin of the rounded object preferably a gel-ball according to the present invention completely encloses the core. In one aspect, “completely encloses” refers to that the outer skin completely covers, wraps or seals the core (i.e., 100% enclosed). In another aspect, the outer skin of the rounded object preferably a gel-ball according to the present invention at least partially encloses the core. In another aspect, “at least partially encloses” means that the outer skin encloses at least about 10%, about 20%, about 30%, about 40%, about 50%, about 60%, about 70%, about 80%, about 90%, about 95%, about 98%, or about 99% of the core.

In one aspect, the outer skin has a thickness of between about 0.1 mm and about 10 mm, preferably between about 0.1 mm and about 5 mm, more preferably between about 0.1 mm and about 3 mm, more preferably between about 0.1 mm and about 1 mm, or more preferably between about 0.1 mm and about 0.5 mm.

In one aspect, the core comprises a gelling agent. In one aspect, a gelling agent is an additional substance that can gradually transform a latex into a uniform semi-rigid solid gel and maintain its original shape. In one aspect, the gelling agent includes gelatin, carrageenan, xanthan gum, agar, gellan gum, pectin, locust bean gum, konjac flour, curdlan gum, and the combinations thereof. In a preferred aspect, the gelling agent in the core is carrageenan.

In one aspect, the core comprises a humectant. In one aspect, humectant is a hygroscopic (water-absorbing) substance. Humectant is a surfactant that can allow a solid material to be more easily wetted by water through reducing its surface energy. In one aspect, the humectant includes, for example, konjac, honey, glucose syrup, glycerin, ovalbumin, soy protein isolates, xanthan gum, sodium carboxymethyl cellulose, locust bean gum, and the combinations thereof. In a preferred aspect, the humectant is konjac.

In one aspect, the core further comprises a potassium salt. In one aspect, suitable potassium salt described herein includes water soluble potassium salts. Suitable potassium salts include potassium nitrate, potassium chloride, potassium citrate, potassium sulfate, potassium carbonate, potassium phosphate, etc. and a hydrate thereof, and mixtures thereof. In a preferred aspect, the potassium salt is potassium chloride or potassium citrate.

In one aspect, the core has a radius that is suitable to be added in food, feed, beverage, cosmetic or pharmaceutical products, for example, about 1.5-15 mm, preferably about 1.5-7.5 mm, or more preferably about 2.5-6 mm.

The size of the core can vary based on the desired needs of the end product. The core comprises, for example, a diameter of about 0.5-10 mm, preferably about 0.5-5 mm, more preferably about 1-4 mm, or more preferably about 2-3 mm.

In one aspect, the weight of core accounts for about 10-99 wt %, preferably about 50-95 wt %, more preferably about 60-95 wt %, or more preferably about 60-90 wt %, or more preferably about 70-80 wt % of the rounded object preferably a gel-ball. In one aspect, the ratio of the weight of core to the weight of outer skin can be adjusted as long as the two-layer structure can be formed.

In one aspect, the ratio of the radius of core to the thickness of outer skin can be adjusted as long as the two-layer structure can be formed. The ratio of the radius of the core to the thickness of the outer skin is, for example, about 1:9 to 9:1, preferably about 1:5 to 5:1, more preferably about 1:3 to 3:1, or more preferably about 1:2 to 2:1 or more preferably about 1:1.

In one aspect, the gel-ball comprises a first sugar, and the first sugar is distributed in the core, or the outer skin or a combination thereof. In one aspect the first sugar comprises cane sugar, glucose, fructose, lactose, maltose, glucose syrup, fructose and glucose syrup, corn syrup, invert sugar, honey, maple syrup, brown sugar, molasses or any combination thereof. In a preferred aspect, the first sugar is cane sugar, and fructose and glucose syrup.

In one aspect, the rounded object preferably a gel-ball according to the present invention further comprises an acid regulator and/or a second sugar. In one aspect, the acid regulator and/or the second sugar penetrates the outer skin and core and is dispersed throughout the rounded object preferably the gel-ball. The acid regulator and/or the second sugar may also be present only in the core or only in the outer skin.

In one aspect, the acid regulator is an additive that is used to adjust or maintain the pH value (acidity or alkalinity). In one aspect, the acid regulator can be organic acid or inorganic acid, alkali, neutralizer, or buffer. In one aspect, suitable acid regulator described herein includes ascorbic acid, phosphoric acid, tartaric acid, lactic acid, citric acid, malic acid, sodium citrate and the combination thereof. In a preferred aspect, acid regulator is citric acid.

In one aspect, the second sugar described herein includes but not limited to cane sugar (e.g. from cane or beet), glucose, fructose, lactose, maltose, glucose syrup, fructose and glucose syrup, corn syrup, invert sugar, honey, maple syrup, brown sugar, molasses and any combination thereof. In a preferred aspect, the sugars contain cane sugar and/or fructose and glucose syrup.

In one aspect, the acid regulator and/or the second sugar is present in an amount sufficient to provide a Brix value of about 20 to 60%, preferably about 30 to 50%, more preferably 40 to 45%. In one aspect, the acid regulator is present in an amount sufficient to provide a pH value of about 3.0 to 5.0, preferably about 3.5 to 4.2.

In one aspect, the rounded object preferably a gel-ball has a radius that is suitable to be added in food, feed, beverage, cosmetic or pharmaceutical products, for example, about 2-20 mm, preferably about 2.5-12 mm, or more preferably about 2.5-6 mm.

The diameter of the gel-ball can vary and can be dependent on the end use. In one aspect, the gel-ball for Boba tea comprises a diameter between 2-20 mm, or preferably between about 2 mm and about 10 mm, preferably between about 5 mm and about 8 mm, more preferably about 8 mm.

In one aspect, the present invention relates to a process of manufacturing the rounded object preferably a gel-ball suitable to be added to food, feed, beverage, cosmetic or pharmaceutical products, wherein the process includes:
providing a first mixture that includes 0.4-2.5 wt % of a gelling agent, 0.4-2.5 wt % of the humectant, 0.01-1 wt % of a potassium salt, 0.5-10 wt % of a calcium salt, and 80-95 wt % of water;
heating the first mixture to 60-95° C., preferably 80-95° C. and maintaining the temperature of the first mixture;
providing a second mixture that includes 0.1-1 wt % of an alginate salt and 75-90 wt % of water;
heating the second mixture to 45-95° C., preferably 65-85° C. and maintaining the temperature of the second mixture;
adding the first mixture with the temperature of 60-95° C., preferably 80-95° C. maintained to the second mixture with the temperature of 45-95° C., preferably 65-85° C. maintained drop by drop to shape up a ball; and filtering the ball to obtain the gel-ball.

In one aspect, the present invention relates to a process of manufacturing a gel-ball suitable to be added to food, feed, beverage, cosmetic or pharmaceutical products, wherein the process includes:
providing a first mixture that includes 0.4-2.5 wt % of a gelling agent, 0.4-2.5 wt % of the humectant, 0.01-1 wt % of a potassium salt, 0.5-10 wt % of a calcium salt, 0-60 wt %, preferably 10-60 wt % of a first sugar, and 24-98.7 wt % of water;
heating the first mixture to 60-95° C., preferably 80-95° C. and maintaining the temperature of the first mixture;
providing a second mixture that includes 0.1-5 wt % of an alginate salt and 75-99.9 wt % of water;
heating the second mixture to 45-95° C., preferably 65-85° C. and maintaining the temperature of the second mixture;
adding the first mixture with the temperature of 60-95° C., preferably 80-95° C. maintained to the second mixture with the temperature of 45-95° C., preferably 65-85° C. maintained drop by drop to shape up a ball; and filtering the ball to obtain the gel-ball.

In one aspect, the first mixture includes 0-60 wt %, or preferably 10-60 wt %, or more preferably 10-55 wt % of the first sugar. In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof.

In one aspect, the second mixture includes the first sugar. In one aspect, the second mixture may further include other suitable sugars as described in addition to the first sugar. In one aspect, the second mixture includes zero of the first sugar, but includes other suitable sugars as described, which makes the first mixture and the second mixture include different sugars. In one aspect, the other suitable sugars are selected from the group of the first sugar. In one aspect, the first mixture and the second mixture include different kinds of the first sugars.

In one aspect, the first mixture comprises a gelling agent described herein. In one aspect, the first mixture comprises about 0.4-2.5 wt %, preferably about 0.4-1.5 wt %, more preferably about 0.5-2.5 wt %, more preferably 1.0-2.5 wt %, more preferably 1.5-2.5 wt %, or more preferably 2.0-2.5 wt % of gelling agent, such as carrageenan, based on the weight of the first mixture.

In one aspect, the first mixture comprises a humectant described herein. In one aspect, the first mixture comprises about 0.4-2.5 wt %, preferably about 0.4-1.5 wt %, more preferably about 0.5-2.5 wt %, more preferably about 1.0-2.5 wt %, more preferably 1.5-2.5 wt %, or more preferably 2.0-2.5 wt % of humectant, such as konjac, based on the weight of the first mixture.

In one aspect, the first mixture further comprises a calcium salt. In one aspect, calcium salt includes those selected from the group consisting of calcium acetate, calcium benzoate, calcium bromate, calcium bromide, calcium chlorate, calcium chloride, calcium chromate, calcium dihydrogen phosphate, calcium dithionate, calcium formate, calcium gluconate, calcium glycerophosphate, calcium hydrogen sulfide, calcium iodide, calcium lactate, calcium metasilicate, calcium nitrate, calcium nitrite, calcium pantothenate, calcium perchlorate, calcium permanganate, calcium phosphate, calcium phosphinate, calcium salicylate, calcium succinate, and a mixture thereof. In a preferred aspect, calcium salt is calcium lactate or calcium chloride. In one aspect, the calcium salt of the first mixture does not include calcium alginate. In one aspect, the first mixture includes about 0.5-10 wt %, preferably about 0.5-9 wt %, more preferably about 0.5-8 wt %, more preferably about 0.5-7 wt %, more preferably about 0.5-6 wt %, more preferably about 0.5-5 wt %, more preferably about 0.5-4 wt %, more preferably about 0.5-3 wt %, more preferably about 0.5-2 wt %, more preferably about 0.5-1 wt %, more preferably about 1-5 wt %, more preferably about 1-8 wt %, more preferably about 1-10 wt %, more preferably about 5-8 wt %, more preferably about 5-10 wt %, or more preferably about 9-10 wt % of calcium salt, such as calcium lactate or calcium chloride, based on the weight of the first mixture.

In one aspect, the first mixture comprises a potassium salt described herein. In one aspect, the first mixture includes about 0.01-1 wt %, preferably about 0.01-0.5 wt %, more preferably about 0.01-0.1 wt %, more preferably about 0.01-0.05 wt %, more preferably about 0.05-5 wt %, more preferably about 0.05-1 wt %, more preferably about 0.05-0.5 wt %, more preferably about 0.05-0.1 wt %, more preferably about 0.1-1 wt %, or more preferably about 0.5-1 wt % of potassium salt, such as potassium chloride or potassium citrate, based on the weight of the first mixture.

In one aspect, the first mixture comprises water. In one aspect, the first mixture comprises water so that the percentage of all components is 100%. In one aspect, the first mixture includes about 60-99 wt %, preferably about 65-99 wt %, more preferably about 70-99 wt %, more preferably about 80-99 wt %, more preferably about 90-99 wt %, more preferably about 60-95 wt %, more preferably about 65-95 wt %, more preferably about 75-95 wt %, more preferably about 80-95 wt %, more preferably about 85-95 wt %, more preferably about 60-90 wt %, more preferably about 65-90 wt %, more preferably about 70-90 wt %, more preferably about 75-90 wt %, more preferably about 80-90 wt %, more preferably about 91.19-91.50 wt %, more preferably about 91.19-93.5 wt %, more preferably about 91.50-93.5 wt %, or more preferably about 85-90 wt %, or more preferably about 24-98.7 wt %, or more preferably about 25-50 wt %, or of water, based on the weight of the first mixture.

In one aspect, the second mixture comprises an alginate salt. In one aspect, suitable alginate salts described herein includes sodium alginate, potassium alginate. In one aspect, the alginate salt of the second mixture does not include calcium alginate. In a preferred aspect, alginate salt is sodium alginate. In one aspect, the second mixture includes about 0.01-1 wt %, preferably about 0.05-0.1 wt %, more preferably about 0.1-1 wt %, more preferably about 0.2-0.1 wt %, more preferably about 0.3-1 wt %, more preferably about 0.4-1 wt %, more preferably about 0.5-1 wt %, more preferably about 0.6-1 wt %, more preferably about 0.7-1 wt %, more preferably about 0.8-1 wt %, more preferably about 0.9-1 wt %, more preferably about 0.1-0.9 wt %, more preferably about 0.1-0.8 wt %, more preferably about 0.1-0.7 wt %, more preferably about 0.1-0.6 wt %, more preferably about 0.1-0.5 wt %, more preferably about 0.1-0.4 wt %, more preferably about 0.1-0.3 wt %, more preferably about 0.2-0.5 wt %, more preferably about 0.2-1.0 wt %, or more preferably about 0.5-1.0 wt %, or more preferably about 0.1-5 wt %, or more preferably about 0.1-2 wt % of alginate salt, such as sodium alginate, based on the weight of the second mixture.

In one aspect, the second mixture comprises water. In one aspect, the second mixture comprises water so that the percentage of all components is 100%. In one aspect, the second mixture includes about 60-99 wt %, preferably about 65-99 wt %, more preferably about 70-99 wt %, more preferably about 80-99 wt %, more preferably about 90-99 wt %, more preferably about 60-95 wt %, more preferably about 65-95 wt %, more preferably about 75-95 wt %, more preferably about 80-95 wt %, more preferably about 85-95 wt %, more preferably about 60-90 wt %, more preferably about 65-90 wt %, more preferably about 70-90 wt %, more preferably about 75-90 wt %, more preferably about 80-90 wt %, more preferably about 99-99.5 wt %, more preferably about 99-99.8 wt %, more preferably about 99.5-99.8 wt %, or more preferably about 85-90 wt %, or more preferably about 75-99.9 wt %, or more preferably about 95-99.9 wt % of water, based on the weight of the second mixture.

In one aspect, the process according to the present invention includes heating the first mixture to about 60-95° C., preferably about 65-95° C., more preferably about 75-95° C., more preferably about 80-95° C., more preferably about 75-80° C., more preferably about 80-95° C., more preferably about 60-85° C., about 60-80° C., more preferably about 60-75° C., more preferably about 60-70° C., more preferably about 60-65° C., more preferably about 70-80° C., about 70-85° C., or more preferably about 80-90° C. and maintaining the temperature of the first mixture.

In another aspect, the process according to the present invention includes heating the second mixture to about 45-95° C., preferably about 50-95° C., more preferably about 55-95° C., more preferably about 60-95° C., more preferably about 60-80° C., more preferably about 60-95° C., more preferably about 65-95° C., more preferably about 70-95° C., more preferably about 75-95° C., more preferably about 80-95° C., more preferably about 85-95° C., more preferably about 90-95° C., more preferably about 50-90° C., more preferably about 55-90° C., more preferably about 65-90° C., more preferably about 70-90° C., more preferably about 75-90° C., or more preferably about 65-85° C. and maintaining the temperature of the second mixture.

In one aspect, the temperature of the first mixture is maintained for at least about 5 minutes before adding to the second mixture. In another aspect, the temperature of the first mixture is maintained above 60° C. until the gelling agent, the humectant and any additives have dissolved in the water. In one aspect, the temperature of the first mixture is maintained for at least about 5 minutes, preferably about 10 minutes, more preferably about 15 minutes, more preferably about 20 minutes, more preferably about 25 minutes, more preferably about 30 minutes, more preferably about 35 minutes, or more preferably about 60 minutes before adding to the second mixture. In another aspect, the temperature of the first mixture is maintained for about 10-20 minutes, preferably about 10-25 minutes, more preferably about 10-30 minutes, more preferably about 15-35 minutes, or more preferably about 15-60 minutes before adding to the second mixture.

In one aspect, the temperature of the first mixture is maintained at above 60° C. for at least about 5 minutes before adding to the second mixture.

In one aspect, the temperature of the second mixture is maintained for at least about 3 minutes before the first mixture is added to the second mixture. In another aspect, the temperature of the second mixture is maintained for at least about 5 minutes, preferably about 8 minutes, more preferably about 10 minutes, more preferably about 15 minutes, more preferably about 20 minutes, more preferably about 25 minutes, more preferably about 30 minutes, about more preferably 35 minutes, or more preferably about 60 minutes before the first mixture is added to the second mixture. In another aspect, the temperature of the second mixture is maintained for about 3-30 minutes, preferably about 5-10 minutes, more preferably 10-15 minutes, more preferably about 10-20 minutes, more preferably about 10-25 minutes, more preferably about 10-30 minutes, more preferably about 15-35 minutes, or more preferably about 15-60 minutes before the first mixture is added to the second mixture.

In one aspect, the viscosity of the first mixture is determined under a temperature of 60-95° C., preferably 80-95° C. In one aspect, the viscosity of the first mixture is at least about 10 cP, preferably at least about 10000 cP, or more preferably at least about 120000 cP. In one aspect, the viscosity of the first mixture is about 10-120000 cP, preferably about 10-3000 cP, or more preferably about 10000-100000 cP.

In one aspect, the viscosity of the second mixture is determined under a temperature of 45-95° C., preferably 65-85° C. In one aspect, the viscosity of the second mixture is about 1-1000 cP, preferably about 1-500 cP, or more preferably about 10-1000 cP.

In one aspect, the first mixture is added to the second mixture by any means that can deliver the fluid drop by drop. For example, a suitable apparatus for adding the first mixture to the second mixture includes dropper, calibrated pipette, burette, drop pipette, handheld separatory funnel, etc. In one aspect, the first mixture is added to the second mixture drop by drop. The size of the drop can vary and may depend on the viscosity of the first mixture. For example, the diameter of the drop can be about 5-30 mm depending on the viscosity of the first mixture and the size of the drop pipette. In one aspect, the first mixture is added to the second mixture drop by drop at any rate or any time interval between successive drops as long as the drop from the first mixture maintains a distinct separation from one another.

In one aspect, the ball is maintained in the second mixture at about 45-95° C., preferably about 50-95° C., more preferably about 55-95° C., more preferably about 60-95° C., more preferably about 65-95° C., more preferably about 70-95° C., more preferably about 75-95° C., more preferably about 80-95° C., or more preferably about 85-95° C., preferably 65-85° C. for about 3-30 minutes, more preferably about 3-8 minutes, more preferably about 8-15 minutes, more preferably about 5-30 minutes, more preferably about 10-30 minutes, about more preferably 15-30 minutes, more preferably about 20-30 minutes, more preferably about 25-30 minutes or more preferably about 3-15 minutes before the ball is filtered.

In one aspect, the process according to the present invention further comprises cooling down the filtered ball to below 40° C. In one aspect, the process according to the present invention further comprises cooling down the filtered ball to below 35° C., preferably to below 30° C., preferably to below 25° C. or preferably to below 20° C.

In one aspect, the process according to the present invention further comprises providing a third mixture that includes 0-2 wt % of an acid regulator, 48-100 wt % of a second sugar, and/or 0-50 wt % of water, based on the weight of the third mixture.

In one aspect, the third mixture includes an acid regulator described herein. In one aspect, the third mixture includes about 0-2 wt %, preferably about 0-1 wt %, about 0-0.5 wt %, more preferably about 0.1-5 wt %, more preferably about 0.1-2 wt %, more preferably about 0.1-1 wt %, more preferably about 0.01-1 wt %, more preferably about 0.01-2 wt %, more preferably about 1-2 wt %, or more preferably about 0.5-1 wt % of acid regulator, such as citric acid, based on the weight of the third mixture.

In one aspect, the third mixture includes a second sugar described herein. In one aspect, the third mixture includes about 48-100 wt %, preferably about 50-100 wt %, more preferably about 60-100 wt %, more preferably about 70-100 wt %, more preferably about 80-100 wt %, more preferably about 90-100 wt %, more preferably about 40-90 wt %, more preferably about 50-52 wt %, or more preferably about 50-90 wt % of sugar, such as cane sugar and/or fructose and glucose syrup, based on the weight of the third mixture. In one aspect, the second sugar includes about 1-50 wt % of cane sugar and about 1-80 wt % of fructose and glucose syrup. In one aspect, the second sugar includes about 5-25 wt %, preferably about 5-10 wt %, or more preferably about 10-25 wt % of cane sugar and about 25-40 wt %, preferably about 25-47 wt %, or more preferably about 40-47 wt % of fructose and glucose syrup.

In one aspect, the third mixture comprises water so that the percentage of all components is 100%. In one aspect, the third mixture includes about 0-70 wt %, preferably about 0-60 wt %, more preferably about 0-50 wt %, more preferably about 0-40 wt %, more preferably about 0-30 wt %, more preferably about 0-20 wt %, more preferably about 0-10 wt %, more preferably about 10-60 wt %, more preferably about 10-50 wt %, more preferably about 10-40 wt %, more preferably about 10-30 wt %, more preferably about 10-20 wt %, more preferably about 25-50 wt %, more preferably about 25-30 wt %, more preferably about 20-50 wt %, more preferably about 46-49 wt %, more preferably about 46-49.99 wt %, more preferably about 49-49.99 wt %, or more preferably about 15-50 wt % of water, based on the weight of the third mixture.

In one aspect, the third mixture has about 40% brix value. In one aspect, the third mixture has about 20-60%, preferably about 30-60%, more preferably about 40-60%, more preferably about 50-60%, more preferably about 20-50%, more preferably about 30-50%, more preferably about 40-50%, or more preferably about 40-45% brix value. In one aspect, the third mixture has a pH value of about 3-5, preferably about 3-4.5, or more preferably about 3.5-4.2.

In one aspect, the filtered balls can be added to the third mixture together in one time. In one aspect, the third mixture penetrates the outer skin and core of the gel-ball and is dispersed throughout the gel-ball. In one aspect, the third mixture is absorbed by the outer skin and/or the core of the gel-ball and is dispersed throughout the gel-ball.

In one aspect, the rounded object preferably a gel-ball is sterilized for about 5-15 minutes at a temperature of about 95-121° C. In another aspect, the rounded object preferably a gel-ball is sterilized for about 5-30 minutes, preferably about 5-25 minutes, more preferably about 5-20 minutes, more preferably about 5-15 minutes, more preferably about 5-10 minutes, or more preferably about 10-15 minutes at a temperature of about 100-121° C., preferably about 105-121° C., more preferably about 110-121° C., more preferably about 115-121° C., more preferably about 95-120° C., more preferably about 100-120° C., more preferably about 105-120° C., more preferably about 110-120° C., or more preferably about 115-120° C.

The present invention further relates to a rounded object preferably a gel-ball obtained by the process described herein.

Without being bound by theory, the inventors of the present invention discovered that the temperatures of the first mixture and the second mixture have significant effect on the properties, such as heat resistance of the rounded object preferably a gel-ball. Without being bound by theory, it is believed that when adding the first mixture drop by drop to the second mixture, heating the first mixture and maintaining it at the temperature of about 60-95° C., preferably 80-95° C.; and heating the second mixture and maintaining it at the temperature of about 45-95° C., preferably about 65-85° C., it allows the rounded object preferably a gel-ball of the present invention to form a two-layer structure of outer skin and core that is heat resistant, i.e. the gel-ball maintains integrity when exposed to a temperature of 95-121° C.

### Frozen Application

The present invention provides use of the gel-ball discussed above in frozen applications. The present invention provides a frozen gel-ball, wherein the gel-ball is the gel-ball discussed above.

The inventors discovered that the heat-resistant or the double-layered gel-balls of the present invention are also cold-resistant and can also be used in frozen applications. The inventors also discovered that all alginate gel-balls are cold resistant and thus can be used in frozen applications.

The terms in the section “frozen application” such as “gel-ball”, “elastic”, “maintaining integrity”, “gelling agent”, “humectant”, “alginate salt”, “potassium salt”, “calcium salt”, “water soluble calcium salt”, “sugar”, “first sugar”, “second sugar”, “acid regulator”, “diameter”, “viscosity”, “a suitable apparatus for adding the first mixture to the second mixture” and so on are the same as those described in the previous section “gel-ball” if applicable.

The frozen, cold-resistant gel-balls can exhibit elasticity and chewiness at cold temperatures, e.g. below 0° C., or from 0° C. to −50° C., or from −10° C. to −20° C., or from 0° C. to −10° C., or from −12° C. to −18° C. In one aspect, the frozen gel balls do not have to be thawed prior to use in frozen application. The gel balls are consumed in the frozen food without thawing and are still elastic and/or chewy at cold temperatures.

The present invention provides a frozen gel-ball suitable to be added to food, feed, beverage, cosmetic or pharmaceutical products, comprising a gelling agent, an alginate salt, a humectant, and a first sugar, wherein the frozen gel-ball includes a core and an outer skin that at least partially encloses the core, and the core and the outer skin lie in two different layers that are separable from each other before frozen.

The present invention also provides a frozen gel-ball suitable to be added to food, feed, beverage, cosmetic or pharmaceutical products, comprising: a core comprising a core gel network comprising a humectant and a gelling agent; and an outer skin at least partially enclosing said core, said skin comprising a skin gel network comprising calcium alginate, wherein the core and the outer skin lie in two different layers that are separable from each other before frozen.

In one aspect, the frozen gel-ball comprises a first sugar, and the first sugar is distributed in the core, or the outer skin or a combination thereof, and wherein the first sugar comprises cane sugar, glucose, fructose, lactose, maltose, glucose syrup, fructose and glucose syrup, corn syrup, invert sugar, honey, maple syrup, brown sugar, molasses or any combination thereof.

In one aspect, the frozen gel-ball maintains integrity when exposed to a temperature of from 0° C. to −50° C., or from −10° C. to −20° C., or from 0° C. to −10° C., or from −12° C. to −18° C. In one aspect, the frozen gel-ball maintains elasticity and chewiness when exposed to a temperature of from 0° C. to −50° C., or from −10° C. to −20° C., or from 0° C. to −10° C., or from −12° C. to −18° C.

In one aspect, the frozen gel-ball comprises firmness, texture, elasticity, mouthfeel and/or chewiness desirable in a food product. The frozen gel-ball is chewy and has a desired texture and mouthfeel compared to a frozen tapioca ball. The gel-ball can be analyzed by a pressure test conducted on a Texture Analyser. The Texture Analyser is used in a compression/force test mode with a Pre-test speed of 0.5 mm/second. The deformation distance of a frozen gel-ball at a set force, e.g., 80N, is determined. In one aspect, the deformation distance of the frozen gel-ball is greater than the deformation distance of a frozen tapioca ball in a pressure test at 80N. The deformation distance of the frozen gel-ball described herein is greater than the deformation distance of a frozen tapioca ball by at least 1.1 fold, or at least 1.2 fold, or at least 1.3 fold, or at least 1.4 fold, or at least 1.5 fold, or at least 1.6 fold, or at least 1.7 fold, or at least 1.8 fold or at least 1.9 fold, or at least 2 fold, or at least 3 fold, or at least 4 fold, or at least 5 fold.

In one aspect, the frozen gel-ball has a deformation distance of 6-11 mm, or 6-10 mm, or 7-10 mm, or 8-10 mm when a pressure force of 80N is conducted onto the frozen gel ball. In one aspect, the frozen gel-ball has a deformation distance of at least 6.5 mm in pressure test at 80N, preferably at least 7.0 mm, or preferably at least 7.5 mm.

In one aspect, the gelling agent is described above and in a preferred aspect, the gelling agent is carrageenan.

In one aspect, the humectant is described above and in a preferred aspect, the humectant is konjac.

In one aspect, the alginate salt is described above and in a preferred aspect, alginate salt is sodium alginate.

In one aspect, the gel-ball further comprises a potassium salt. In a preferred aspect, the potassium salt is potassium chloride or potassium citrate.

The present invention also provides a process of manufacturing a frozen gel-ball suitable to be added to food, feed, beverage, cosmetic or pharmaceutical products, wherein the process includes:
providing a first mixture that includes 0.4-2.5 wt % of a gelling agent, 0.4-2.5 wt % of the humectant, 0.01-1 wt % of a potassium salt, 0.5-10 wt % of a calcium salt, 0-60 wt % (preferably 10-60 wt % or more preferably 25-60 wt % or more preferably 10-55 wt %) of a first sugar, and 24-98.7 wt % of water;
heating the first mixture to 60-95° C., preferably 80-95° C. and maintaining the temperature of the first mixture;
providing a second mixture that includes 0.1-5 wt % of an alginate salt and 75-99.9 wt % of water;
heating the second mixture to 45-95° C., preferably 65-85° C. and maintaining the temperature of the second mixture;
adding the first mixture with the temperature of 60-95° C., preferably 80-95° C. maintained to the second mixture with the temperature of 45-95° C., preferably 65-85° C. maintained drop by drop to shape up a ball;
filtering the ball to obtain the gel-ball, and
freezing the gel-ball to obtain the frozen gel-ball.

In one aspect, the gel-ball is frozen to obtain the frozen gel-ball first and then the frozen gel ball is added in food, feed, beverage, cosmetic or pharmaceutical products, preferably in cold food or cold beverage. In one aspect, the gel-ball is added in food, feed, beverage, cosmetic or pharmaceutical products, preferably in cold food or cold beverage first and then frozen together with the food and beverages, etc.

In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof. In one aspect, the second mixture includes the first sugar. In one aspect, the second mixture may further include other suitable sugars as described in addition to the first sugar. In one aspect, the first mixture and the second mixture include different kinds of sugars.

In one aspect, the temperature of the first mixture is maintained for at least 10 minutes before adding to the second mixture. In one aspect, the temperature of the second mixture is maintained for at least 3 minutes before the first mixture is added to the second mixture. In one aspect, the ball is maintained in the second mixture at 45-95° C., preferably 65-85° C. for 3-30 minutes before the ball is filtered.

In one aspect, the calcium salt is described above and in a preferred aspect, the calcium salt is calcium lactate or calcium chloride. In one aspect, the alginate salt is described as above and in a preferred aspect, the alginate salt is sodium alginate.

In one aspect, the process further comprises providing a third mixture that includes 0-2 wt % of an acid regulator, 48-100 wt % of a second sugar, and 0-50 wt % of water.

In one aspect, the acid regular is described above and in a preferred aspect, the acid regulator is citric acid.

In one aspect, the second sugar comprises cane sugar, glucose, fructose, lactose, maltose, glucose syrup, fructose and glucose syrup, corn syrup, invert sugar, honey, maple syrup, brown sugar, molasses or any combination thereof. In one aspect, the second sugar includes 1-50 wt % cane sugar and 1-80 wt % of fructose and glucose syrup.

In one aspect, the process further comprises heating the third mixture to a temperature of 45-95° C. and maintaining the temperature of the third mixture, and adding the gel-ball to the third mixture with the temperature of 45-95° C. maintained.

In one aspect, the gel-ball is sterilized for 5-15 minutes at a temperature of 95-121° C. prior to being frozen.

The present invention provides a frozen gel-ball obtained by the process discussed. In one aspect, the gel-ball obtained from the process under the section “gel-ball” is frozen to obtain a frozen gel ball of the present invention.

The present invention provides use of the gel-ball discussed in frozen application. The present invention provides use of the frozen gel-ball discussed in food, feed, beverage, cosmetic or pharmaceutical products. In one aspect, the frozen gel-ball is used in cold food or cold beverage. In one aspect, the frozen gel-ball is used in an ice cream food product.

### EXAMPLES

The following examples are presented to further illustrate and explain the present invention and should not be taken as limiting in any regard.

### Example 1

### Preparation of a Double-Layered Gel-Ball

A first mixture was prepared according to the ingredients in Table 1. The first mixture was heated to the indicated temperature for the indicated period in Table 1.

TABLE 1

| Ingredient | Gel-ball 1 | Gel-ball 2 | Gel-ball 3 |
|---|---|---|---|
| Carrageenan | 0.4% | 1.5% | 2.5% |
| Konjac flour | 0.4% | 1.5% | 2.5% |
| Potassium chloride | 0.01% | 0.5% | 1% |
| Calcium lactate | 8% | 5% | 1% |
| Water | 91.19% | 91.50% | 93.5% |
| Total | 100.00% | 100.00% | 100.00% |
| Temperature | 75° C. | 80° C. | 95° C. |
| Holding time of the solution | 10 minutes | 10 minutes | 10 minutes |
| before the first mixture | | | |
| drops to the second mixture | | | |

A second mixture was prepared according to the ingredients in Table 2. The second mixture was heated to the indicated temperature for the indicated period in Table 2.

TABLE 2

| Ingredient | Gel-ball 1 | Gel-ball 2 | Gel-ball 3 |
|---|---|---|---|
| Sodium alginate | 0.2% | 0.5% | 1.0% |
| Water | 99.8% | 99.5% | 99% |
| Total | 100% | 100% | 100% |
| Temperature | 60° C. | 80° C. | 95° C. |
| Holding time of the | 10 minutes | 10 minutes | 10 minutes |
| solution before the first | | | |
| mixture drops to the | | | |
| second mixture | | | |

The first mixture maintained at the temperature and time indicated in Table 1 was added drop by drop to the second mixture maintained at the temperature and time indicated in Table 2 to form gel-balls. The gel-balls stayed in the second mixture for the time indicated in Table 3. The gel-balls are then filtered.

TABLE 3

| | Gel-ball 1 | Gel-ball 2 | Gel-ball 3 |
|---|---|---|---|
| Temperature of the | 60° C. | 80° C. | 95° C. |
| second mixture | | | |
| Maintained time | 3 minutes | 8 minutes | 15 minutes |

A third mixture was prepared according to the ingredients in Table 4. The filtered gel-ball was added to the third mixture. The Brix value of the third mixture is maintained at 40%.

TABLE 4

| Ingredient | Gel-ball 1 | Gel-ball 2 | Gel-ball 3 |
|---|---|---|---|
| Citric acid | 0.01% | 1% | 2% |
| Cane sugar | 25% | 10% | 5% |
| Fructose and | 25% | 40% | 47% |
| glucose syrup | | | |
| Water | 49.99% | 49% | 46% |
| Total | 100.00% | 100.00% | 100.00% |

### Comparative Examples 1-3

A first mixture was prepared according to the ingredients in Table 5. The first mixture was heated to the indicated temperature for the indicated period in Table 5.

TABLE 5

| | Comparative | Comparative | Comparative |
|---|---|---|---|
| Ingredient | Example 1 | Example 2 | Example 3 |
| Carrageenan | 0.4% | 0.4% | 0.4% |
| Konjac flour | 0.4% | 0.4% | 0.4% |
| Potassium chloride | 0.01% | 0.01% | 0.01% |
| Calcium lactate | 0 | 1% | 1% |
| Water | 99.19% | 98.19% | 98.19% |
| Total | 100.00% | 100.00% | 100.00% |
| Temperature | 90° C. | 90° C. | 90° C. |
| Holding time of the solution | 10 minutes | 10 minutes | 10 minutes |
| before the first mixture | | | |
| drops to the second mixture | | | |

A second mixture was prepared according to the ingredients in Table 6. The second mixture was heated to the indicated temperature for the indicated period in Table 6.

TABLE 6

| | Comparative | Comparative | Comparative |
|---|---|---|---|
| Ingredient | Example 1 | Example 2 | Example 3 |
| Sodium alginate | 1.0% | 1.0% | 0% |
| Water | 99% | 99% | 100% |
| Total | 100% | 100% | 100% |
| Temperature | 80° C. | 15° C. | 15° C. |
| Holding time of the | 10 minutes | 10 minutes | 10 minutes |
| solution before the first | | | |
| mixture drops to the | | | |
| second mixture | | | |

The first mixture maintained at the temperature and time indicated in Table 5 was added drop by drop to the second mixture maintained at the temperature and time indicated in Table 6 to form gel-balls. The gel-balls were left in the second mixture for the time indicated in in below Table 7. The gel-balls are then filtered.

TABLE 7

| | Comparative | Comparative | Comparative |
|---|---|---|---|
| | Example 1 | Example 2 | Example 3 |
| Solution temperature | 80° C. | 15° C. | 15° C. |
| Maintained time | 1 minutes | 5 minutes | 10 minutes |

A third mixture was prepared according to the ingredients in Table 8. The filtered gel-ball was added to the third mixture. The Brix value of the third mixture is maintained at 40%.

TABLE 8

| | Comparative | Comparative | Comparative |
|---|---|---|---|
| Ingredient | Example 1 | Example 2 | Example 3 |
| Citric acid | 0.01% | 0.01% | 0.01% |
| Canc sugar | 25% | 25% | 25% |
| Fructose and | 25% | 25% | 25% |
| glucose syrup | | | |
| Water | 49.99% | 49.99% | 49.99% |
| Total | 100.00% | 100.00% | 100.00% |

The gel-balls produced according to the present invention (i.e. Gel-ball 1, Gel-ball 2 and Gel-ball 3) and Comparative Example 1-3 were heated to 121° C. for sterilization for 15 minutes and observed. The results are shown in Table 9.

TABLE 9

| | | Outer skin and | |
|---|---|---|---|
| | Shape | core are solid | Appearance |
| Gel-ball 1 | Grape- | Yes | Elastic, the mouthfeel of core |
| | shape | | partially compromised after |
| | | | sterilization |
| Gel-ball 2 | Grape- | Yes | Elastic, the mouthfeel of core |
| | shape | | partially compromised after |
| | | | sterilization |
| Gel-ball 3 | Grape- | Yes | Elastic, substantially no change |
| | shape | | before and after sterilization |
| Comparative | Cannot | No | Cannot form a ball shape |
| Example 1 | form a | | |
| | ball shape | | |
| Comparative | Sphere | Single solid | Can form in shape, but cannot |
| Example 2 | | layer | form an obvious double layer |
| | | | structure |
| Comparative | Sphere | Single solid | Can form in shape, but cannot |
| Example 3 | | layer | form a double layer structure |

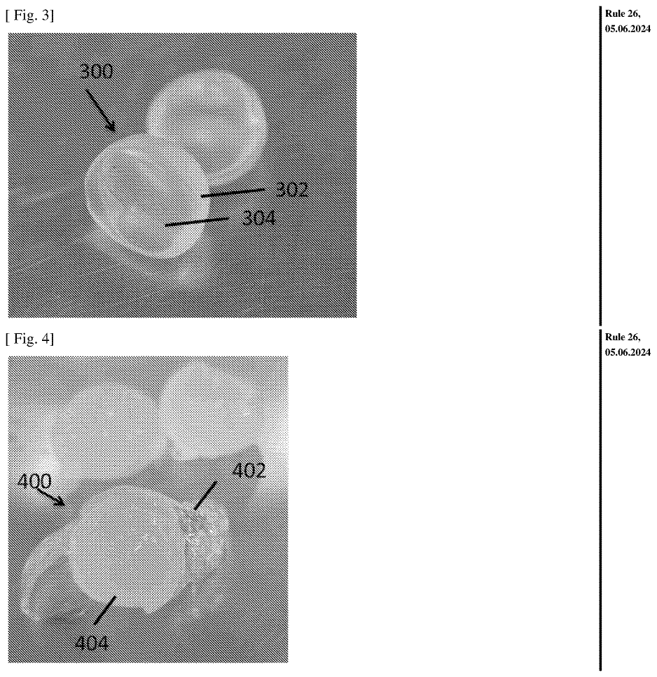

The overall appearance of the gel-ball of Example 1 and the structure of the gel-ball 200 after the outer skin 202 has been peeled off from the core 204 are shown in FIG. 2. The gel-ball of Example 2 was sliced into half and the cross section of the gel-ball was observed and shown in FIG. 3. The gel-ball 300 includes an outer skin 302 and a core 304. The overall appearance of the gel-ball of

Example 3 and the structure of the gel-ball 400 after the outer skin 402 has been peeled off from the core 404 are shown in FIG. 4. FIGS. 2-4 show that the gel-balls obtained according to the process of the present invention have two layers, i.e. the core and the outer skin. There is a distinctive boundary between the core and the outer skin of the gel-balls and both the core and the outer skin are solid.

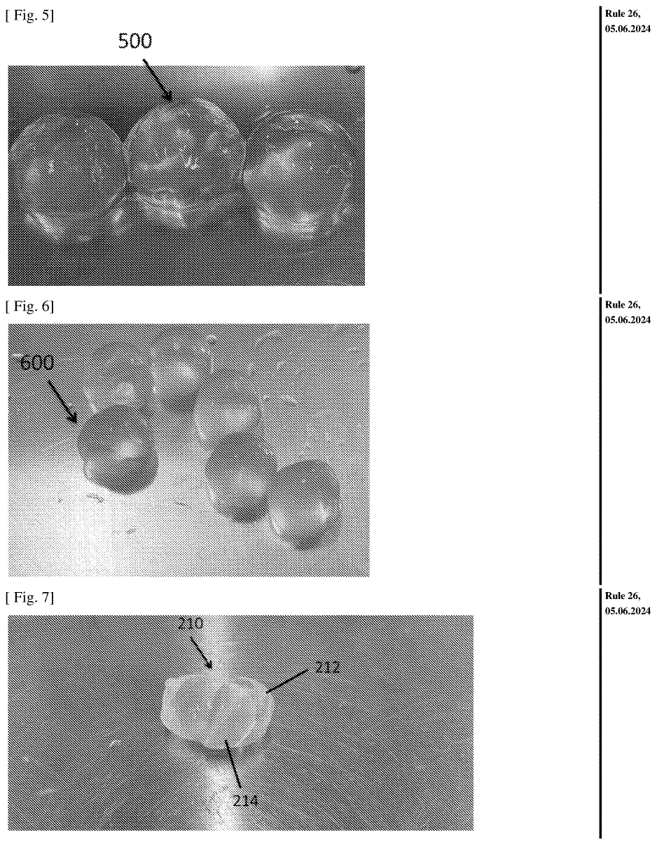

It is worth noting that Comparative Example 1 (FIG. not shown) cannot form a ball shape. The overall appearance of the gel-ball 500 of Comparative Example 2 is shown in FIG. 5. The overall appearance of the gel-ball 600 of Comparative Example 3 is shown in FIG. 6. Although gel-balls of Comparative Examples 2-3 can form into a sphere, FIGS. 5-6 show that the gel-balls of Comparative Examples 2-3 do not have a two-layer structure.

The appearance of the gel-ball of Example 1 after sterilization under 121° C. for 15 minutes is shown in FIG. 7. The gel-ball 210 still has an outer skin 212 and a core 214 after sterilization and the integrity of the gel-ball 210 is maintained.

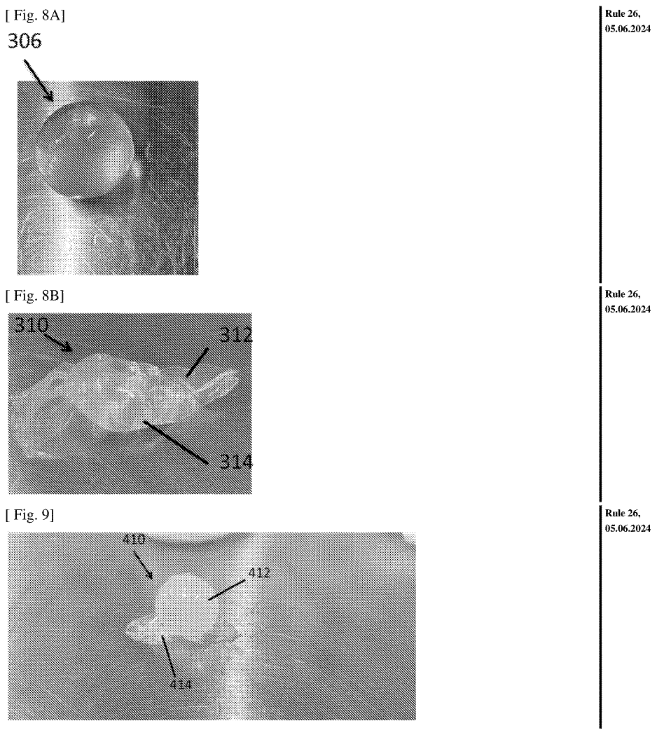

The appearance of the gel-ball of Example 2 before and after sterilization under 121° C. for 15 minutes is shown in FIGS. 8A and 8B, respectively. It can be observed from FIG. 8A that the gel-ball 306 has a smooth surface. FIG. 8B shows that there are still two layers even after sterilization under 121° C. for 15 minutes. Even though the core 314 and the outer skin 312 of the gel-ball 310 are deformed after sterilization, the outer skin 312 still enclosed the core 314 of the gel-ball 310. In addition, it can be seen that both the outer skin 312 and the core 314 of the gel-ball 310 maintain in solid form after sterilization.

It should be noted that the deformation of the two-layered gel-ball 310 after sterilization was due to the pressure change caused from the high-temperature sterilization process (121° C.) to cooling stage. Lots of small bubbles exist in the liquid mixture due to lack of exhaust process in the laboratory samples, and thus the outer skin cannot be completely restored to its original size and shape due to the pressure change after going through the sterilization (which led to expansion) and cooling stage. This Example aims to indicate the two-layered structure of the gel-ball 310 and thus no exhaust process was adopted, leading to the deformation. In fact, in the actual manufacturing process, the deformation may be addressed by using e.g. a vacuum exhaust process.

The appearance of the gel-ball of Example 3 after sterilization under 121° C. for 15 minutes is shown in FIG. 9. The gel-ball 410 still has an outer skin 412 and a core 414 after sterilization and the integrity of the gel-ball 410 is maintained.

The appearance of the gel-ball of the Comparative Example 2 after sterilization under 121° C. for 15 minutes is shown in FIG. 10. Although the gel-ball 510 maintained a ball shape structure after sterilization, it does not have a two-layer structure.

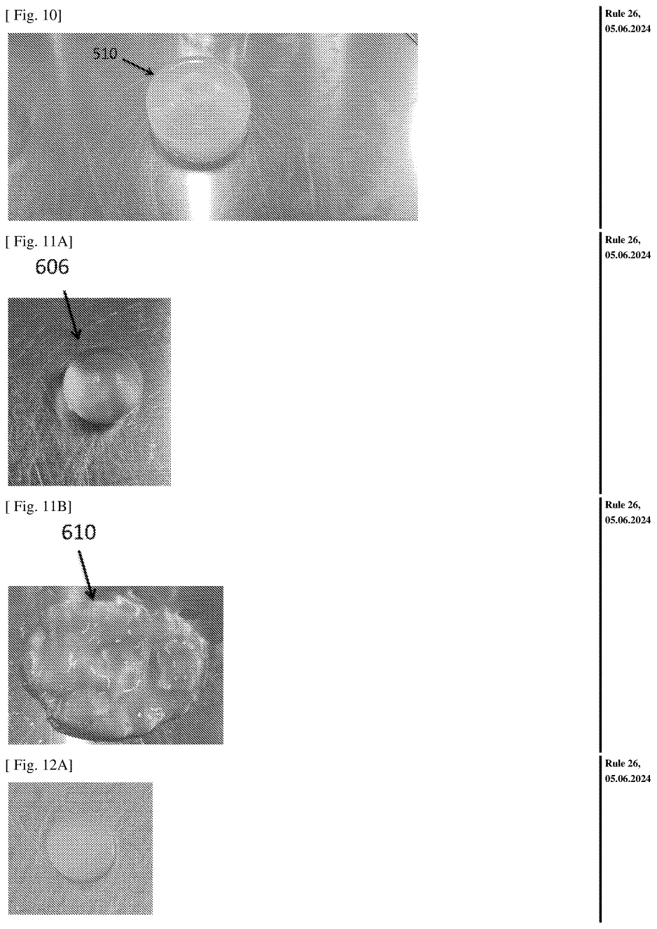

The appearance of the gel-ball of Comparative Example 3 before and after sterilization under 121° C. for 15 minutes is shown in FIGS. 11A and 11B, respectively. It can be observed from FIG. 11A that the surface of the gel-ball 606 of the Comparative Example 3 is rough with frosted appearance. FIG. 11B shows that the gel-ball 610 of the Comparative Example 3 completely collapsed after sterilization and it transformed from a ball-shaped solid to an amorphous slurry after sterilization under 121° C. for 15 minutes.

### Example 4

### Preparation of Frozen Gel-Balls 1-3

The gel-balls of Examples 1-3 are placed in a freezer until they are frozen to obtain frozen gel-balls 1-3.

### Example 5

### Preparation of Frozen Gel-Balls 4-6.

A first mixture was prepared according to the ingredients in Table 10. The first mixture was heated to the indicated temperature for the indicated period in Table 10. The powder ingredients are mixed first and then they are added into liquid ingredients (water and syrup). The mixture is blended and heated to a temperature around 90-95° C.

TABLE 10

| | Frozen | Frozen | Frozen |
|---|---|---|---|
| Ingredient | gel-ball 4 | gel-ball 5 | gel-ball 6 |
| Calcium | 5.00% | 5.00% | 5.00% |
| lactate | | | |
| Carrageenan | 1.50% | 1.50% | 1.50% |
| Konjac | 1.50% | 1.50% | 1.50% |
| Potassium | 0.50% | 0.50% | 0.50% |
| chloride | | | |
| Fructose and | 0.00% | 15.00% | 45.00% |
| glucose syrup | | | |
| (Glucose: | | | |
| 31.51% and | | | |
| Fructose: | | | |
| 42.35%) | | | |
| Cane sugar | 10.00% | 10.00% | 10.00% |
| Water | 81.50% | 66.50% | 36.50% |
| Total | 100.00% | 100.00% | 100.00% |
| Temperature: | 90-95° C. | 90-95° C. | 90-95° C. |
| Maintain | 15 mins | 15 mins | 15 mins |
| time: | | | |

A second mixture was prepared according to the ingredients in Table 11. The second mixture was heated to the indicated temperature in Table 11. Sodium alginate and optional sugar are added into water for blending, and they are heated to the setting temperature at 60° C.

TABLE 11

| | Frozen | Frozen | Frozen |
|---|---|---|---|
| Ingredient | gel-ball 4 | gel-ball 5 | gel-ball 6 |
| Sodium alginate | 1.00% | 1.00% | 1.00% |
| Water | 99.00% | 99.00% | 99.00% |
| Total | 100% | 100% | 100% |
| Temperature | 60° C. | 60° C. | 60° C. |

The first mixture is added drop by drop to the second mixture and they are maintained for 5 minutes as shown in Table 12.

TABLE 12

| | Frozen | Frozen | Frozen |
|---|---|---|---|
| | gel-ball 4 | gel-ball 5 | gel-ball 6 |
| Temperature | 60° C. | 60° C. | 60° C. |
| Maintained time | 5 mins | 5 mins | 5 mins |

As described above, the gel-balls are then filtered and soaked in sugar water solution such as the third mixture. The gel-balls are sterilized for 15 minutes under a temperature of 121° C. The gel-balls are placed in a freezer until they are frozen to obtain frozen gel-balls.

### Example 6

Appearance of frozen gel-balls 4-6 is described in Table 13. The gel-ball was analyzed by a pressure test conducted on a Texture Analyser. The Texture Analyser is used in a compression/force test mode with a Pre-test speed of 0.5 mm/second. The deformation distance of a frozen gel-ball at a set force of 80 Newtons was determined. Pressure tests under a force of 80N are conducted onto the frozen gel-balls to determine the deformation distance/extent that the frozen gel-balls can take under the external force.

Tapioca balls are purchased commercially from the market. Frozen gel-balls 4-6 and tapioca balls have similar sizes.

TABLE 13

| | Appearance | Pressure test |
|---|---|---|
| | (after frozen) | (80N): mm |
| Frozen | Frozen-resistant, | 7.59 |
| gel-ball 4 | easy to chew, soft mouth | |
| | feel with limited resilience | |
| Frozen | Frozen-resistant, | 8.66 |
| gel-ball 5 | easy to chew, soft mouth | |
| | feel with resilience | |
| Frozen | Frozen-resistant, | 9.88 |
| gel-ball 6 | easy to chew, soft mouth | |
| | feel with better resilience | |
| Frozen | hard mouth feel and not | 5.92 |
| tapioca balls | easy to chew, taste like ice | |
| | cube without resilience | |

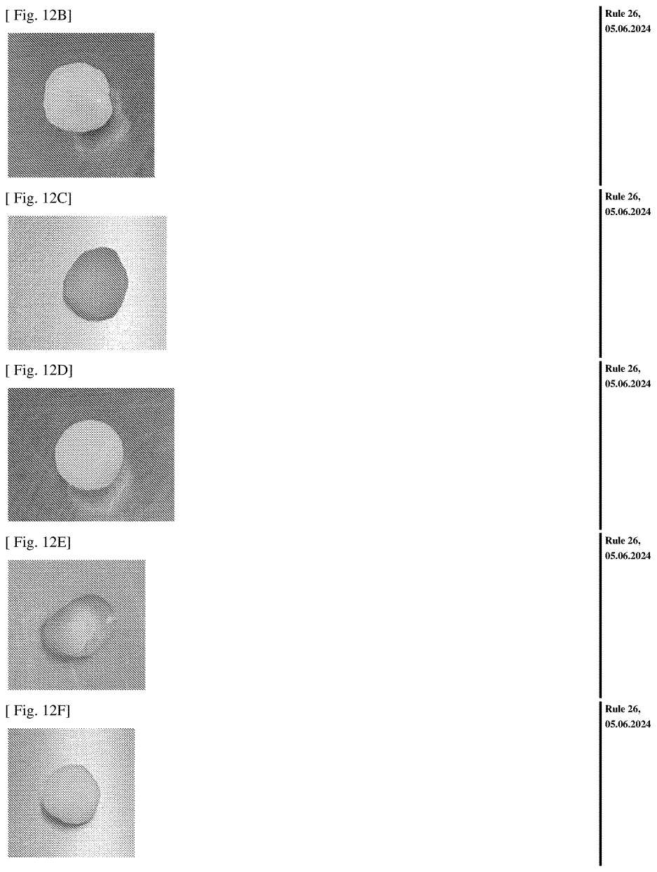

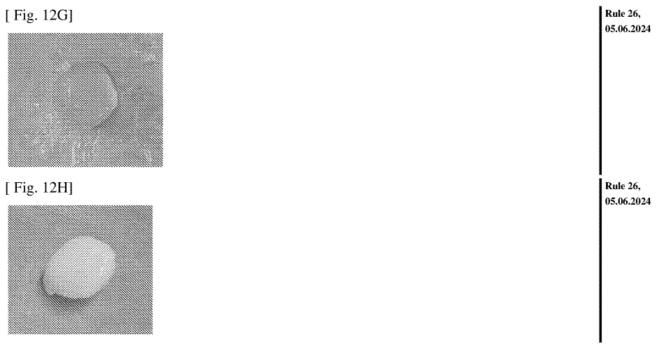

Frozen gel-balls 4-6 before and after frozen are shown in FIGS. 12A-12F, respectively. Tapioca balls before and after frozen are shown in FIGS. 12G and 12H, respectively. The diameters of frozen gel-balls 4-6 and tapioca balls are around 12 mm.

Frozen gel-balls 1-3 are cold resistant (FIGS. not shown). Frozen gel-balls 4-6 are cold resistant, but tapioca balls are not. Frozen gel-balls 4-6 have a longer deformation distance than frozen tapioca balls when the pressure tests are conducted onto the balls, which indicates that frozen gel-balls 4-6 are more chewy and elastic than frozen tapioca balls.

The pressure tests demonstrate the elasticity of the frozen gel-balls even at cold temperatures. The appearance of the frozen gel-balls is different in the cold temperatures than the gel-balls before frozen as they are no longer transparent but are cloudy/milky in appearance. In contrast, the frozen tapioca-based gel balls are not chewy as the frozen gel-balls of the present invention when used in frozen application and do not have the elasticity and chewiness of gel balls that are cold-resistant. The appearance of the frozen tapioca gel balls is cloudy/milky similar to the frozen gel balls but the texture and elasticity are different.

Thus, frozen gel-balls 1-6 are more suitable to being used in frozen applications such as cold food or cold beverages than frozen tapioca balls.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

Representative features of the present invention are set out in the following clauses, which stand alone or may be combined, in any combination, with one or more features disclosed in the text of the Specification.

The present invention is as set out in the following clauses:
Clause 1. A frozen gel-ball suitable to be added to food, feed, beverage, cosmetic or pharmaceutical products, comprising a gelling agent, an alginate salt, a humectant, and a first sugar, wherein the frozen gel-ball includes a core and an outer skin that at least partially encloses the core, and the core and the outer skin lie in two different layers that are separable from each other before frozen, preferably the frozen gel-ball is cold-resistant.
Clause 2. A frozen gel-ball suitable to be added to food, feed, beverage, cosmetic or pharmaceutical products, comprising:
   a core comprising a core gel network comprising a humectant and a gelling agent; and
   an outer skin at least partially enclosing said core, said skin comprising a skin gel network comprising calcium alginate,
   wherein the core and the outer skin lie in two different layers that are separable from each other before frozen, preferably the frozen gel-ball is cold-resistant.
Clause 3. The frozen gel-ball of any one of the preceding clauses, wherein the frozen gel-ball comprises a first sugar, and the first sugar is distributed in the core, or the outer skin or a combination thereof, and wherein the first sugar comprises cane sugar, glucose, fructose, lactose, maltose, glucose syrup, fructose and glucose syrup, corn syrup, invert sugar, honey, maple syrup, brown sugar, molasses or any combination thereof.
Clause 4. The frozen gel-ball of any one of the preceding clauses, wherein the core comprises a core gel network, and the outer skin comprises a skin gel network, and before frozen, the core gel network and the skin gel network do not intermingle with each other at the junction between the core and the outer skin.
Clause 5. The frozen gel-ball of any one of the preceding clauses, wherein the frozen gel-ball is cold-resistant when exposed to a temperature of from 0° C. to −50° C., or from −10° C. to −20° C., or from 0° C. to −10° C., or from −12° C. to −18° C.
Clause 6. The frozen gel-ball of any one of the preceding clauses, wherein the outer skin completely encloses the core.
Clause 7. The frozen gel-ball of any one of the preceding clauses, wherein the outer skin has a thickness of between 0.1 mm and 10 mm.
Clause 8. The frozen gel-ball of any one of the preceding clauses, wherein the gelling agent is carrageenan.
Clause 9. The frozen gel-ball of any one of the preceding clauses, wherein the humectant is konjac.
Clause 10. The frozen gel-ball of any one of the preceding clauses, wherein the gel-ball further comprises a potassium salt.
Clause 11. The frozen gel-ball of clause 10, wherein the potassium salt is potassium chloride or potassium citrate.
Clause 12. The frozen gel ball of any one of the preceding clauses further comprising an acid regulator and/or a second sugar.
Clause 13. A process of manufacturing a frozen gel-ball suitable to be added to food, feed, beverage, cosmetic or pharmaceutical products, wherein the process includes:
   providing a first mixture that includes 0.4-2.5 wt % of a gelling agent, 0.4-2.5 wt % of the humectant, 0.01-1 wt % of a potassium salt, 0.5-10 wt % of a calcium salt, 0-60 wt %, preferably 10-60 wt % of a first sugar, and 24-98.7 wt % of water;
   heating the first mixture to 60-95° C., preferably 80-95° C. and maintaining the temperature of the first mixture;
   providing a second mixture that includes 0.1-5 wt % of an alginate salt and 75-99.9 wt % of water;
   heating the second mixture to 45-95° C., preferably 65-85° C. and maintaining the temperature of the second mixture;
   adding the first mixture with the temperature of 60-95° C., preferably 80-95° C. maintained to the second mixture with the temperature of 45-95° C., preferably 65-85° C. maintained drop by drop to shape up a ball;
   filtering the ball to obtain the gel-ball, and
   freezing the gel-ball to obtain the frozen gel-ball, preferably the frozen gel-ball is cold-resistant.
Clause 14. The process of clause 13, wherein the first sugar comprises cane sugar, glucose, fructose, lactose, maltose, glucose syrup, fructose and glucose syrup, corn syrup, invert sugar, honey, maple syrup, brown sugar, molasses or any combination thereof.
Clause 15. The process of clause 13 or 14, wherein the temperature of the first mixture is maintained for at least 10 minutes before adding to the second mixture.
Clause 16. The process of any one of clauses 13-15, wherein the temperature of the second mixture is maintained for at least 3 minutes before the first mixture is added to the second mixture.
Clause 17. The process of any one of clauses 13-16, wherein the ball is maintained in the second mixture at 45-95° C., preferably 65-85° C. for 3-30 minutes before the ball is filtered.
Clause 18. The process of any one of clauses 13-17, wherein the calcium salt is calcium lactate or calcium chloride.
Clause 19. The process of any one of clauses 13-18, wherein the alginate salt is sodium alginate.
Clause 20. The process of any one of clauses 13-19, further comprising providing a third mixture that includes 0-2 wt % of an acid regulator, 48-100 wt % of a second sugar, and 0-50 wt % of water.
Clause 21. The process of clause 20, wherein the acid regulator is citric acid.
Clause 22. The process of clause 20 or 21, wherein the second sugar comprises cane sugar, glucose, fructose, lactose, maltose, glucose syrup, fructose and glucose syrup, corn syrup, invert sugar, honey, maple syrup, brown sugar, molasses or any combination thereof, or preferably the second sugar comprises 1-50 wt % cane sugar and 1-80 wt % of fructose and glucose syrup.
Clause 23. The process of any one of clauses 20-22, further comprising heating the third mixture to a temperature of 45-95° C. and maintaining the temperature of the third mixture, and adding the gel-ball to the third mixture with the temperature of 45-95° C. maintained.
Clause 24. The process of any one of clauses 13-23, wherein the gel-ball is sterilized for 5-15 minutes at a temperature of 95-121° C. prior to being frozen.
Clause 25. A frozen gel-ball obtained by the process of any one of clauses 13-24.
Clause 26, Use of the gel-ball as defined in any one of the preceding clauses in frozen application.
Clause 27. Use of the frozen gel-ball of any one of clauses 1-12 and 25 in food, feed, beverage, cosmetic or pharmaceutical products, preferably in cold food or cold beverage.
Clause 28. A gel-ball suitable to be added to food, feed, beverage, cosmetic or pharmaceutical products, comprising:
   a core comprising a core gel network comprising a humectant and a gelling agent; and
   an outer skin at least partially enclosing said core, said skin comprising a skin gel network comprising calcium alginate,
   wherein the core and the outer skin lie in two different layers that are separable from each other.
Clause 29. The gel-ball of claim 28, wherein the core gel network and the skin gel network do not intermingle with each other at the junction between the core and the outer skin.
Clause 30. The gel-ball of clause 28 or 29, wherein the gel-ball maintains integrity when exposed to a temperature of 95-121° C.
Clause 31. The gel-ball of any one of clauses 28-30, wherein the gel-ball maintains integrity when exposed to a temperature of 95-121° C. for 5 to 15 minutes.
Clause 32. The gel-ball of any one of clauses 28-31, wherein the outer skin completely encloses the core.
Clause 33. The gel-ball of any one of clauses 28-32, wherein the outer skin has a thickness of between 0.1 mm and 10 mm.
Clause 34. The gel-ball of any one of clauses 28-33, wherein the gelling agent is carrageenan.
Clause 35. The gel-ball of any one of clauses 28-34, wherein the humectant is konjac.
Clause 36. The gel-ball of any one of clauses 28-35, wherein the gel-ball further comprises a potassium salt.
Clause 37. The gel-ball of clause 36, wherein the potassium salt is potassium chloride or potassium citrate.
Clause 38. The gel ball of any one of clauses 28-37, further comprising an acid regulator and/or sugar.
Clause 39. A process of manufacturing a gel-ball suitable to be added to food, feed, beverage, cosmetic or pharmaceutical products, wherein the process includes:
   providing a first mixture that includes 0.4-2.5 wt % of a gelling agent, 0.4-2.5 wt % of the humectant, 0.01-1 wt % of a potassium salt, 0.5-10 wt % of a calcium salt, and 80-95 wt % of water;
   heating the first mixture to 60-95° C., preferably 80-95° C. and maintaining the temperature of the first mixture;
   providing a second mixture that includes 0.1-1 wt % of an alginate salt and 75-90 wt % of water;
   heating the second mixture to 45-95° C., preferably 65-85° C. and maintaining the temperature of the second mixture;
   adding the first mixture with the temperature of 60-95° C., preferably 80-95° C. maintained to the second mixture with the temperature of 45-95° C., preferably 65-85° C. maintained drop by drop to shape up a ball, and filtering the ball to obtain the gel-ball.
Clause 40. The process of clause 39, wherein the temperature of the first mixture is maintained for at least 10 minutes before adding to the second mixture.
Clause 41. The process of clauses 39-40, wherein the temperature of the second mixture is maintained for at least 3 minutes before the first mixture is added to the second mixture.
Clause 42. The process of any one of clauses 39-41, wherein the ball is maintained in the second mixture at 45-95° C., preferably 65-85° C. for 3-30 minutes before the ball is filtered.
Clause 43. The process of any one of clauses 39-42, wherein the calcium salt is calcium lactate or calcium chloride.
Clause 44. The process of any one of clauses 39-43, wherein the alginate salt is sodium alginate.
Clause 45. The process of any one of clauses 39-44, further comprising providing a third mixture that includes 0-2 wt % of an acid regulator, 48-100 wt % of sugars, and 0-50 wt % of water.
Clause 46. The process of clause 45, wherein the acid regulator is citric acid.
Clause 47. The process of clauses 45 or 46, wherein the sugars include 1-50 wt % cane sugar and 1-80 wt % of fructose and glucose syrup.
Clause 48. The process of any one of clauses 45-47, further comprising heating the third mixture to a temperature of 45-95° C. and maintaining the temperature of the third mixture, and adding the gel-ball to the third mixture with the temperature of 45-95° C. maintained.
Clause 49. The process of any one of clauses 39-48, wherein the gel-ball is sterilized for 5-15 minutes at a temperature of 95-121° C.
Clause 50. A gel-ball obtained by the process of any one of claims clauses 39-49.

1. A gel-ball suitable to be added to food, feed, beverage, cosmetic or pharmaceutical products, comprising:
a core comprising a core gel network comprising a humectant and a gelling agent; and
an outer skin at least partially enclosing said core, said skin comprising a skin gel network comprising calcium alginate,
wherein the core and the outer skin lie in two different layers that are separable from each other, wherein the core gel network and the skin gel network do not intermingle with each other at the junction between the core and the outer skin and wherein the gel-ball maintains integrity when exposed to a temperature of 95-121° C. for 5 to 15 minutes.

2. (canceled)

3. (canceled)

4. The gel-ball of claim 1, wherein the gel-ball is cold-resistant when exposed to a temperature of from 0° C. to −50° C.

5. The gel-ball of claim 1, wherein the outer skin completely encloses the core.

6. The gel-ball of claim 1, wherein the outer skin has a thickness of between 0.1 mm and 10 mm.

7. The gel-ball of claim 1, wherein the gelling agent is carrageenan.

8. The gel-ball of claim 1, wherein the humectant is konjac.

9. The gel-ball of claim 1, wherein the gel-ball further comprises a potassium salt.

10. (canceled)

11. The gel ball of claim 1, further comprising an acid regulator and/or sugar.

12. A process of manufacturing a gel-ball suitable to be added to food, feed, beverage, cosmetic or pharmaceutical products, wherein the process includes:
providing a first mixture comprising 0.4-2.5 wt % of a gelling agent, 0.4-2.5 wt % of a humectant, 0.01-1 wt % of a potassium salt, 0.5-10 wt % of a calcium salt, and 80-95 wt % of water;
heating the first mixture to 60-95° C., and maintaining the temperature of the first mixture between 60-95° C.;
providing a second mixture comprising 0.1-1 wt % of an alginate salt and 75-90 wt % of water;
heating the second mixture to 45-95° C., and maintaining the temperature of the second mixture between 45-95° C.;
adding the first mixture to the second mixture drop by drop to form a ball, and
filtering the ball to obtain the gel-ball.

13. The process of claim 12, wherein the temperature of the first mixture is maintained for at least 10 minutes before adding to the second mixture and wherein the temperature of the second mixture is maintained for at least 3 minutes before the first mixture is added to the second mixture.

14. (canceled)

15. (canceled)

16. The process of claim 12, wherein the calcium salt is calcium lactate or calcium chloride.

17. The process of claim 12, wherein the alginate salt is sodium alginate.

18. The process of claim 12, further comprising providing a third mixture that includes-comprising 0-2 wt % of an acid regulator, 48-100 wt % of sugars, and 0-50 wt % of water.

19. (canceled)

20. (canceled)

21. The process of claim 12, further comprising heating the third mixture to a temperature of 45-95° C. and maintaining the temperature of the third mixture and adding the gel-ball to the third mixture with the temperature of 45-95° C. maintained.

22. The process of claim 12, wherein the gel-ball is sterilized for 5-15 minutes at a temperature of 95-121° C.

23. (canceled)

24. The process of claim 12, wherein the process further comprises freezing the gel-ball to obtain the frozen gel-ball, wherein the frozen ball is cold-resistant.

25. A gel-ball obtained by the process of claim 12.

26. (canceled)

27. A frozen gel-ball suitable to be added to food, feed, beverage,
cosmetic or pharmaceutical products, comprising:
a core comprising a core gel network comprising a humectant and a gelling agent; and
an outer skin at least partially enclosing said core, said skin comprising a skin gel network comprising calcium alginate,
wherein the core and the outer skin lie in two different layers that are separable from each other before frozen, wherein the frozen gel-ball is cold-resistant.

28. The frozen gel-ball of claim 27, wherein the frozen gel-ball comprises a first sugar, and the first sugar is distributed in the core, or the outer skin or a combination thereof, and wherein the first sugar comprises cane sugar, glucose, fructose, lactose, maltose, glucose syrup, fructose and glucose syrup, corn syrup, invert sugar, honey, maple syrup, brown sugar, molasses or any combination thereof.

29. The frozen gel-ball of claim 27, wherein the frozen gel-ball is cold-resistant when exposed to a temperature of from 0° C. to −50° C., or from −10° C. to −20° C., or from 0° C. to −10° C., or from −12° C. to −18° C.

30-35. (canceled)
